(19) United States
(12) Patent Application Publication
(10) Pub. No.: US 2024/0140548 A1
(43) Pub. Date: May 2, 2024

(54) Motorcycle Handlebar Fuel Jug

(71) Applicant: Dimitri Delport, Long Beach, CA (US)

(72) Inventor: Dimitri Delport, Long Beach, CA (US)

(21) Appl. No.: 18/473,072

(22) Filed: Sep. 22, 2023

Related U.S. Application Data
(60) Provisional application No. 63/381,512, filed on Oct. 28, 2022.

(51) Int. Cl. B62J 9/21; B62J 9/27; B62J 11/04

(52) U.S. Cl. CPC B62J 9/21; B62J 9/27; B62J 11/04

(57) ABSTRACT

A bottle device is provided. The bottle device comprises a main body; a neck; a handlebar groove positioned on the bottom side of the main body, the handlebar groove includes a center section, the center section is detachably attached to a plurality of handlebar clamps; a strap groove positioned in the main body; and a cap detachably connected to the neck.

### FIELD OF THE INVENTION

The present invention relates to motorcycle accessories. More specifically, the present invention is a liquid storage device that attaches to the handlebar of a motorcycle.

### BACKGROUND OF THE INVENTION

When it comes to the choice of vehicles, there are hundreds of different vehicles to choose from. Depending on the person's preference, the choice of vehicle will vary from person to person. Though on rare occasions, there are people that chooses motorcycle over a typical four-wheeled vehicle. One issue with motorcycle is the lack of storage for the user. Since motorcycles are two-wheeled, it is not designed to store and hold many different items such as a standard four-wheeled vehicle. In addition, the lack of storage space for the user can be detrimental when it comes to finding space for the essentials, such as a bottle of water. Furthermore, a motorcycle's fuel tank is typically significantly smaller than a standard vehicle. Thus, fuel is important to store for a vehicle.

An objective of the present invention is to provide a storage device alongside a motorcycle. The present invention provides a storage device that is used to store additional liquid alongside a motorcycle. The present invention is a bottle used to store liquid on the handlebar of a motorcycle or of the likes.

### SUMMARY OF THE INVENTION

A bottle device is disclosed. The bottle device comprises a main body; a neck; a handlebar groove positioned on the bottom side of the bottle, the handlebar groove includes a center section, the center section is detachably attached to a plurality of handlebar clamps; a strap groove positioned in the main body; and a cap detachably connected to the neck.

In one embodiment, the strap groove of the bottle device is a wide and thin fissure found around the bottle.

In some embodiments, the bottle device includes the center section that is a rectangular cavity.

In some other embodiments, the bottle device includes the strap groove positioned perpendicularly to the length of the main body.

### BRIEF DESCRIPTION OF THE DRAWINGS

FIG. 1 is an illustration of one embodiment of the present invention.

FIG. 2 is a front view of the present invention.

FIG. 3 is a rear view of the present invention.

FIG. 4 is a right-side view of the present invention.

FIG. 5 is a left-side view of the present invention.

FIG. 6 is a bottom plan view of the present invention.

FIG. 7 is a top plan view of the present invention.

FIG. 8 is a perspective view illustrating the insertion of handlebar clamps on the underside cavity of the present invention.

FIG. 9 is a perspective view illustrating the present invention with a handlebar of a motorcycle.

### DETAIL DESCRIPTIONS OF THE INVENTION

All illustrations of the drawings are for the purpose of describing selected versions of the present invention and are not intended to limit the scope of the present invention.

The present invention provides a storage device alongside a motorcycle. The present invention provides a storage device that is used to store additional liquid alongside a motorcycle. The present invention is a bottle used to store liquid on the handlebar of a motorcycle or of the likes.

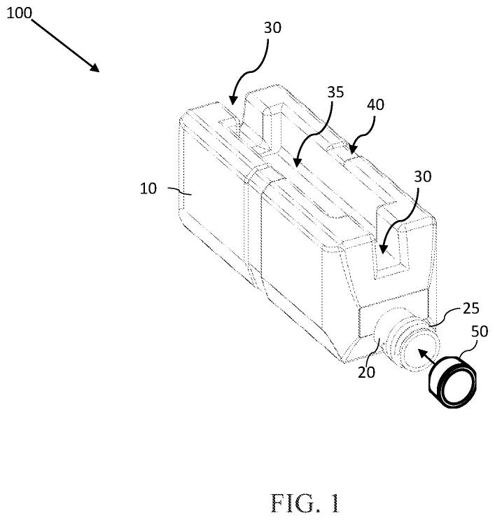

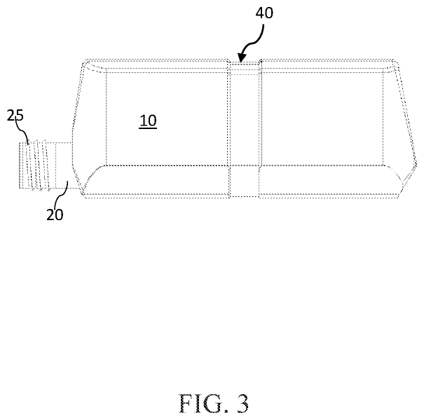

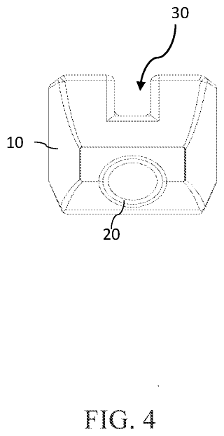

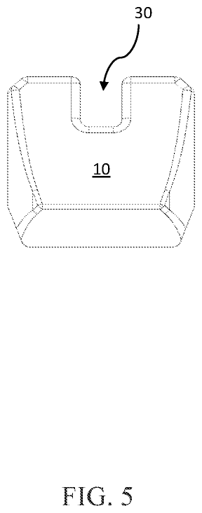

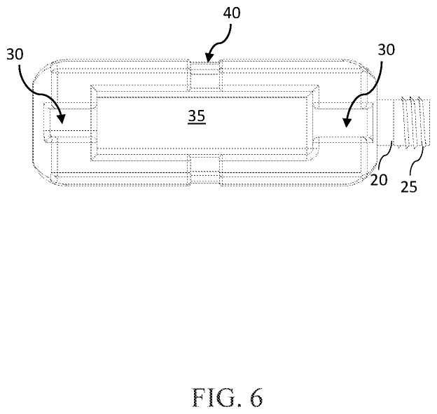

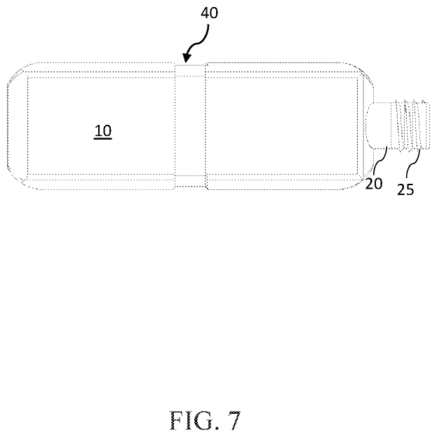

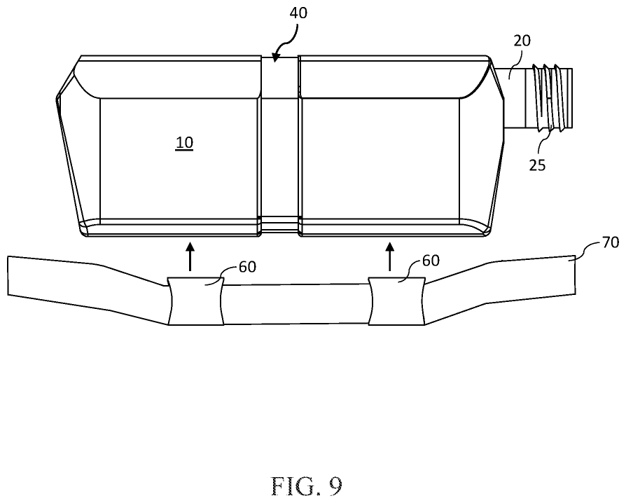

As shown in FIGS. 1-9, the present invention provides a bottle device 100 that comprises a main body 10, a neck 20, a handlebar groove 30, and a strap groove 40.

In one embodiment, the overall shape of the main body 10 can be a rectangular prism. The main body 10 is uniquely designed to attach and fasten against the handlebar 70 of a motorcycle. The bottle device 100 further comprises a neck 20, and a handlebar groove 30, and a strap groove 40.

In one embodiment, the neck 20 is the circular spout found a side (on the right side) of the bottle.

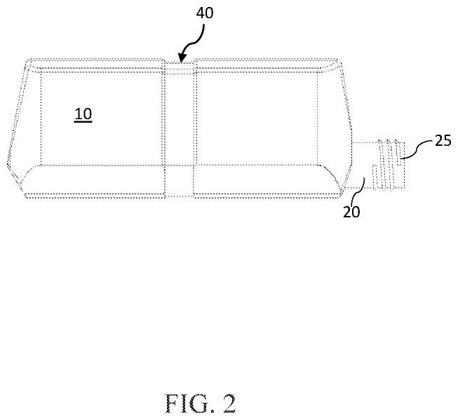

As shown in FIGS. 1-4, neck 20 can be a hollow cylindrical spout protruding from the body member 10. More specifically, the neck 20 protrudes outwards from the small surface of the body member 10 as shown in FIGS. 1 and 2.

The neck 20 can be used as an entry point for the insertion of liquid into the bottle device 100. In addition, the neck 20 is also used as an exit point for the ejection of liquid out of the bottle device 100. The neck 20 can further comprise a cap 50 and a spiral groove 25. The spiral groove 25 is an indentation that spirals around the neck 20 and provides a fastening mechanism for the cap 50.

The handlebar groove 30 is a deep crevice that is found on the underside (or any other suitable sides) of the bottle device 100. The handlebar groove 30 is a gap that is positioned on the side (bottom) of the bottle device 100. More specifically, the handlebar groove 30 is parallel to the length of the bottle device 100.

The handlebar groove 30 is designed to allow the bottle device 100 to position tightly against a handlebar 70 of a motorcycle or of the likes as can be seen in 8.

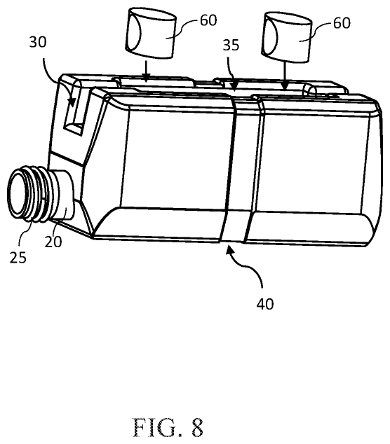

In some embodiments, the handlebar groove 30 may further comprise a center section 35. The center section 35 is a rectangular cavity that is centered on the bottom surface (or other suitable surface) of the bottle device 100. The center section 35 is used as an additional fastening mechanism as it allows the user to insert space for utilizing handlebar clamps 60 as can be seen in FIG. 8. In some embodiments, the handlebar clamps 60 may include a fastening mechanism such as, for example, through the use of a button and matching button hole, Velcro, snap fasteners, magnets, or any other type of fastening mechanisms known in the art.

The strap groove 40 is a wide and thin fissure found around the body member 10. More specifically, the strap grove 40 is found on the center long edge of the body member 10. The strap groove 40 runs perpendicularly to the length of the body member 10. In addition, the strap groove 40 is utilized as a positioning mechanism for straps that are used to fasten the bottle device 100 against a handlebar 70 of a motorcycle.

The strap groove 40 is designed to assist the positioning and securement of the bottle device 100 to a handlebar 70 of a motorcycle.

To use the present invention, the user will first begin by opening the bottle device 100. The user will loosen the cap 50 from the bottle device 100 by means of twisted the cap 50 until it is removed from the neck 20 of the bottle device 100.

The user will insert any liquid they desire through the neck 20 of the bottle device 100. Once the bottle device 100 is filled with the desired liquid, the user will fasten the cap 50 onto the neck 20 of the bottle device 100 to close and encapsulate the liquid within the bottle device 100. Next the user will insert handlebar clamps 60 into the center section 35 of the handlebar grooves 30. In addition, the user will ensure that the handlebar 70 of the desired vehicle in which the bottle device 100 is being attached to are positioned correctly and tightly against the handlebar groove 30. Once the bottle device 100 is positioned against the handlebar 70 of a motorcycle properly, the user will use the strap groove 40 of the bottle device 100 to further fasten the bottle device 100 safely against the handlebar 70 of a motorcycle.

Although the invention has been explained in relation to its preferred embodiment, it is to be understood that many other possible modifications and variations can be made without departing from the spirit and scope of the invention.

What is claimed is:

1. A bottle device comprising:
a main body having an internal space that contains liquid therein;
a neck from which the liquid contained in the main body is poured;
a handlebar groove positioned on the bottom side of the main body, the handlebar groove includes a center section, the center section is detachably attached to a plurality of handlebar clamps;
a strap groove positioned in the main body; and
a cap detachably connected to the neck.

2. The bottle device as claimed in claim 1, wherein the strap groove is a wide and thin fissure found around the main body.

3. The bottle device as claimed in claim 1, wherein the neck includes a plurality of spiral groves.

4. The bottle device as claimed in claim 3, wherein, the main body is flexible.

5. The bottle device as claimed in claim 4, the neck includes a smaller diameter and higher rigidity than the main body.

6. The bottle device as claimed in claim 5, wherein the center section is a rectangular cavity.

7. The bottle device as claimed in claim 5, wherein the strap groove is positioned perpendicularly to the length of the main body.

8. A bottle device comprising:
a main body, the main body at least partially having flexibility;
a neck;
a handlebar groove positioned on the bottom side of the main body, the handlebar groove includes a center section, the center section is detachably attached to a plurality of handlebar clamps, wherein at least one handlebar clamp is removably attached to a handlebar of a motorcycle; and
a strap groove positioned in the main body.

9. The bottle device as claimed in claim 8, wherein the strap groove is a wide and thin fissure found around the main body.

10. The bottle device as claimed in claim 9, wherein the neck includes a plurality of spiral groves.

11. The bottle device as claimed in claim 8, the neck includes a smaller diameter and higher rigidity than the main body.

12. The bottle device as claimed in claim 12, wherein the center section is a rectangular cavity.

13. The bottle device as claimed in claim 13, wherein the strap groove is positioned perpendicularly to the length of the main body.

14. The bottle device as claimed in claim 8 further includes a cap detachably connected to the neck.

15. A bottle device comprising:
a main body having an internal space that contains liquid therein, the main body at least partially having flexibility;
a neck from which the liquid contained in the main body is poured, the neck having a smaller diameter and higher rigidity than the main body;
a handlebar groove positioned on the bottom side of the main body, the handlebar groove includes a center section, the center section is magnetically attached to a plurality of handlebar clamps;
a strap groove positioned in the main body; and
a cap detachably connected to the neck.

16. The bottle device as claimed in claim 15, wherein the strap groove is a wide and thin fissure found around the main body.

17. The bottle device as claimed in claim 15, wherein the neck includes a plurality of spiral groves.

18. The bottle device as claimed in claim 17, wherein the center section is a rectangular cavity.

19. The bottle device as claimed in claim 18, wherein the strap groove is positioned perpendicularly to the length of the main body.

20. The bottle device as claimed in claim 19 further includes a cap detachably connected to the neck.
